(19) United States
(12) Patent Application Publication
(10) Pub. No.: US 2007/0034665 A1
(43) Pub. Date: Feb. 15, 2007

(54) Cutter unit of stapler

(76) Inventors: Toshio Shimizu, Tokyo (JP); Kazuhiko Kishi, Tokyo (JP); Kazuo Higuchi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/571,249

(22) PCT Filed: Oct. 19, 2004
(86) PCT No.: PCT/JP04/15402

§ 371 Date: Mar. 9, 2006

(30) Foreign Application Priority Data
Oct. 20, 2003 (JP) 2003-359916
Oct. 20, 2003 (JP) 2003-359917

(51) Int. Cl. B25C 5/02

(52) U.S. Cl. 227/155; 227/131

(57) ABSTRACT

A cutter unit 10 with a fixed cutter 11 arranged between staple legs and a movable cutter 13 operated from an outer side to an inner side of the staple leg is provided. The cutter unit 10 is arranged slidably between a position advanced into an operation region a movable clincher 5 and a position escaped from the operation region of the movable clincher 5. The cutter unit 10 is advanced to a staple strike out portion to cut the staple leg penetrated through a sheet to be bound, the cutter unit 10 is escaped from the operation region of the movable clincher 5 and thereafter, the staple leg is bent by operating to pivot the movable clincher 5.

### TECHNICAL FIELD

The present invention relates to a stapler for striking out a staple formed in a C-shape to a sheet to be bound and folding to bend staple legs penetrated to a back face side of the sheet to be bound along the back face of the sheet to be bound, particularly relates to a cutter unit of a staple leg for cutting a leg portion of a staple penetrated to a back face side of a sheet to be bound in accordance with a thickness of the sheet to be bound.

Further, the invention relates to a processing apparatus for processing a cutting chip of a stable leg cut by the cutter unit.

### BACKGROUND ART

Normally, in a staple for bundling to bind a plurality of sheets to be bound, there are prepared a number of kinds of staples with different leg lengths thereof in correspondence with a number of sheets to be bound, and a staple with a leg length in accordance with a thickness of the sheets to be bound is charged to a stapler to be used. However, when the thickness of the sheets to be bound is frequently changed, a staple in correspondence with a thickness of sheets to be bound is not recharged one by one at each time and therefore, a staple with a staple leg length in correspondence with sheets to be bound having a maximum thickness which can be bound by the stapler is charged. Therefore, the sheets to be bound thinner than the maximum thickness are bound by the stapler, a length of staple legs penetrated to a side of a back face of the sheets to be bound is prolonged and when the staple leg is bent by a clincher mechanism, there may be brought about a phenomenon in which a front end of the staple leg is penetrated through to the sheets to be bound again to project to a front surface side thereof.

In a stapler or the like installed in a copier or the like for bundling to bind copied sheets, there is proposed a stapler having a cutter unit for cutting a front end portion of a staple leg penetrated through sheets to be bound such that a length of the staple leg projected to a side of a back face of the sheets to be bound becomes substantially constant in order to prevent the staple leg from being projected to a front surface side of the sheets to be bound when the thin sheets to be bound are bound as described above. (For example, JP-B-02-021922.) The cutter unit is constituted by a movable clincher for bending the staple leg penetrated to the side of the back face of the sheets to be bound along the back face of the sheets to be bound and a fixed cutter arranged to be opposed to the movable clincher, a front end portion of the staple leg after penetrating the sheets to be bound is cut by a movable cutter edge formed at the movable clincher and a fixed cutter edge of the fixed cutter, and the front end of the staple leg is cut simultaneously with folding to bend the staple leg by the movable clincher.

Further, there is also proposed a cutter unit provided with a movable cutting member movable in a direction substantially orthogonal to a direction of penetrating a staple leg and formed with a first cutter edge engaged with the staple leg penetrated through the sheets to be bound on a lower side of a movable clincher for engaging the staple leg penetrated through the sheets to be bound for bending the staple leg along the back face of the sheets to be bound, and a fixed cutting member for guiding movement of the movable cutting member is formed with a second cutter edge formed at the fixed cutting member for cutting the staple leg in corporation with the first cutter edge of the movable cutting member. (For example, JP-Y-03-025930.) According to the cutter unit, a front end portion of the staple leg is cut by engaging the staple leg penetrated through the sheets to be bound with the first and the second cutter edges formed at the respective movable and fixed cutting members and moving the movable cutting member along the fixed cutting member, thereafter, the stable leg is bent along the back face of the sheets to be bound by the movable clincher mechanism.

However, according to the mechanism of cutting the staple leg by the above-described movable clincher, respectives of a pair of the movable clinchers are axially supported and supported to be able to pivot, in order to cut the staple leg between the movable cutter edge and the fixed cutter edge of two pieces of the movable clinchers, a high dimensional accuracy is requested for setting a clearance amount or the like between the two cutter edges and therefore, there poses a problem that accuracies are requested in part dimensions, working, integrating or the like, part cost or product cost is increased, further, there is brought about an operational hazard of a failure in cutting, a failure in clinching or the like by wear or the like. Further, a direction of a burr formed at an end face of the staple leg after cutting is formed to an outer side of the staple leg and therefore, there is a concern of being injured by being brought into contact with the staple after binding the staple.

Further, according to the latter of the background art in which the movable cutting member is provided on the lower side of the movable clincher, and the staple leg is cut between the movable cutting member and the fixed cutting member by moving the movable cutting member in the direction substantially orthogonal to the direction of penetrating the staple leg, the movable clincher and the movable cutting member need to be arranged on the same plane and therefore, a length of a portion of the movable clincher engaged with the staple leg cannot be formed to be large and therefore, there poses a problem that a shape of clinching the staple leg cannot be bent in a stable shape. Further, a direction of a burr formed in cutting at a cut end portion of the staple leg is formed in a direction of a side face of the staple and therefore, there is a concern of being injured by being brought into contact with the staple after binding the staple.

Further, according to the stapler having the above-described cutter unit, there may be posed a problem that a cutting chip cut by the cutter unit is scattered at inside of the stapler to be pinched by an operating mechanism of a drive gear, a link or the like to bring about an operational hazard, or dropped onto a circuit board for control to shortcircuit to destruct the circuit.

In order to prevent a hazard brought about by scattering the cutting chip of the staple leg to inside of the stapler, according to the stapler having the cutter unit for cutting a front end portion of the staple leg, there may be provided a cutting chip processing apparatus for preventing the cutting chip of the staple leg cut by the cuter unit from being scattered and accumulating the cutting chip at a predetermined portion. For example, according to a cutting chip processing apparatus of a staple leg described in JP-Y-03-025931, a chute is inclinedly arranged at a cutting chip discharging portion of the cutter unit, a closing member operated to close a lower end opening portion of the chute by the gravitational force is axially attached to be formed at the lower end opening portion of the chute.

According to a stapler of an apparatus included type arranged at a transfer path of a sheet at inside of a copier or the like for binding copied sheets to be bound, there is a case of binding the sheets to be bound in a horizontal state or a vertical state and therefore, it is preferable to be able to install the stapler included in the copier or the like in this way in either of horizontal or vertical direction. However, according to the above-described cutting chip processing apparatus of the staple leg, the chute mounted to the cutting chip discharging portion of the cutter unit is mounted to a front side of the stapler, further, the lower end opening portion of the chute is closed by the gravitational force operation and therefore, for example, when the stapler is installed to direct to the vertical direction to bind sheets to be bound substantially in a vertical state, the cutting chip is not discharged into the chute, further, the lower end opening portion is not opened or closed and therefore, the stapler cannot be installed to direct in a number of directions and the stapler needs to be designed newly.

Patent Reference 1: JP-B-02-021922

Patent Reference 2: JP-Y-03-025930

### DISCLOSURE OF THE INVENTION

It is an object of the invention to resolve the above-described drawback and it is a first problem thereof to provide a stapler capable of providing a stable clinch shape by a movable clincher and having a cutter unit in which there is not a concern of being injured by a burr formed at a front end face of a staple leg after having been cut.

Further, it is a second problem of the invention to provide a stapler having a cutting chip processing apparatus of a staple leg capable of being installed in any direction to be able to bind a sheet to be bound in a horizontal state and a vertical state and firmly guiding a cutting chip to a chip containing portion.

In order to resolve the first problem, a stapler according to the invention is characterized in a stapler folding to bend a staple leg of a staple struck out to a sheet to be bound by a striking mechanism portion and penetrated through the sheet to be bound along a back face of the sheet to be bound by pivoting a pair of movable clinchers from a standby position to an operating position, the stapler is provided with a cutter unit comprising a fixed cutter arranged between a pair of the staple legs and a pair of movable cutters formed with cutter edges operated from outer sides to inner sides of the staple legs relative to the fixed cutter, the cutter unit is arranged slidably between a position advanced into an operation region of the movable clincher opposed to a staple strike out portion of the striking mechanism and a position escaped from the operation region of the movable clincher, the cutter unit is advanced to the operation region of the movable clincher pivoted to the standby position to cut the staple leg penetrated through the sheet to be bound, after escaping the cutter unit from the operation region of the movable clincher, the movable clincher is operated to pivot to the operating position to bend the staple leg cut by a predetermined length along the sheet to be bound.

According to the invention, the front end portion of the staple leg is cut by arranging the fixed cutter between the staple legs and operating the movable cutter from the outer side to the inner side of the staple leg and therefore, in a state of binding the staple, a burr formed at a cutting face of the staple leg is formed to direct to an inner side of the staple leg, that is, to a side of a face of the sheet to be bound, the sheet is bound in a state in which the burr at a front end face of the staple leg is brought into close contact with a side of a back face of the sheet to be bound, even when the hand is brought into contact with the staple leg, the hand is not brought into contact with the burr and there is not a concern of being injured by the burr produced by cutting the staple leg.

Further, the cutter unit is arranged movably between a position opposed to the staple strike out portion constituting the operation region to pivot the movable clincher and a position escaped from the operation region to pivot the movable clincher, in a state of advancing the cutter unit between the movable clinchers pivoted to the standby positions, the staple leg penetrated through the sheet to be bound is cut by the cutter unit, after escaping the cutter unit from the operation region of the movable clincher, the staple leg cut by the movable clincher is bent and therefore, a length of a portion of the movable clincher engaged with the staple leg can be formed to be large, and an excellent binding shape can be provided by engaging the movable clincher with a front end portion of the staple leg.

Further, in order to resolve the second problem, a staple leg cutting chip processing apparatus of a stapler according to the invention is characterized in a staple leg cutting chip processing apparatus of a stapler comprising a striking mechanism portion for striking out a staple to a sheet to be bound, a clincher mechanism portion supported to be able to be operated to be proximate to and remote from the striking mechanism portion for folding to bend a staple leg penetrated through the sheet to be bound along a back face of the sheet to be bound, and a cutter unit formed at inside of the clincher mechanism portion for cutting the staple leg projected to a side of a back face of the sheet to be bound, wherein the cutter unit is constituted by a fixed cutter member and a movable cutter pivotably supported by the fixed cutter member, the cutter unit is provided slidably between a staple strike out position for striking out the staple from the striking mechanism portion and an escaping position on a rear side of the position, the cutter unit is operated to the escaping position on the rear side after advancing to the staple strike out position and cutting the staple leg, at the position, a cutting chip is discharged to a side of a lower face of the cutter unit by way of an opening formed at the cutter unit, and guided into a chip containing portion by way of a chute arranged on the side of the lower face of the cutter unit.

Further, there may be constructed a constitution in which one end side of the chute is supported pivotably by a side of a lower face of a support base slidably supporting the cutter unit, other end side of the chute is arranged in a chip containing portion, and a side of a pivotably supporting portion of the chute is moved to an upper side such that an inclination angle of the chute is increased by operating to pivot the clincher mechanism portion.

According to the invention, the cutting chip of the staple leg is discharged to the chute formed on the side of the lower face of the cutter unit by way of the opening formed at the cutter unit, guided into the chip containing portion by way of the chute and is stored in the chip containing portion and therefore, it can be prevented that the cutting chip of the staple leg cut by the cutter unit advances to a drive mechanism or the like or a clearance of a part of the stapler to bring about an operational hazard or the like in the drive mechanism or the like. Further, the cutter unit for cutting the staple leg is arranged to be able to slide to move between a staple strike out position and an escaping position on a rear side of the position, the cutting chip is discharged to a side of the lower face of the support base by way of openings formed at the cutter unit and the support base and therefore, even when a stapler main body is installed in a horizontal direction or a vertical direction to bind the sheet to be bound arranged in the horizontal direction and the vertical direction, the cutting chip can be guided to be discharged into the chip containing portion by way of the chute and the stapler can be included in various kinds of copiers or the like to bind the sheet to be bound arranged in the horizontal direction and the vertical direction.

Further, the one end side of the chute is supported pivotably by the side of the lower face of the support base slidably supporting the cutter unit, the other end side of the chute is arranged in the chip containing portion, the cutting chip is discharged into the chip containing portion by pivoting the chute to thereby increase the inclination angle of the chute by operating to pivot the clincher mechanism portion and therefore, the cutting chip can firmly be discharged into the chip containing portion and the cutting chip stays in the chute without being scattered into the stapler main body.

### BRIEF DESCRIPTION OF THE DRAWINGS

FIG. 1 is a side view of a stapler having a cutter unit according to a first exemplary embodiment of the invention.

FIG. 2 is a side view of a stapler the same as that of FIG. 1 in a state of operating a clincher mechanism portion.

FIG. 3 is a front view of the clincher mechanism portion in a state of operating a movable clincher to a standby position.

FIG. 4 is a perspective view of the clincher mechanism portion in a state the same as that of FIG. 3.

FIG. 5 is a front view of the clincher mechanism portion in a state of pivoting the movable clincher to an operating position.

FIG. 6 is a perspective view of the clincher mechanism portion in a state the same as that of FIG. 5.

FIG. 7 is a plane view of a staple leg cutting mechanism in a state of being able to receive the staple leg between a fixed cutter and a movable cutter.

FIG. 8 is a plane view of the staple leg cutting mechanism in a state of cutting the staple leg by operating to pivot the movable cutter.

FIG. 9 is a side view of the cutter unit advanced to a staple strike out portion.

FIG. 10 is a perspective view of the cutter unit in a state similar to that of FIG. 8.

FIG. 11 is a side view of the cutter unit operated to an escaping position from the staple strike out portion.

FIG. 12 is a perspective view of the cutter unit in a state similar to that of FIG. 10.

FIG. 13 is a perspective view of the cutter unit in a state of cutting a staple.

FIG. 14 is a side view of a staple embodying a cutting chip processing apparatus of a staple leg according to a second exemplary embodiment of the invention.

FIG. 15 is a side view of a stapler the same as that of FIG. 14 in a state of operating a clincher mechanism portion.

FIG. 16 is a perspective view of a clincher mechanism portion in a state of operating a movable clincher to a standby position.

FIG. 17 is a perspective view of the clincher mechanism portion in a state of pivoting the movable clincher to an operating position.

FIG. 18 is a perspective view showing a cutter unit in a state of being arranged at a staple strike out portion.

FIG. 19 is a perspective view showing the cutter unit in a state of being operated to an escaping position on a rear side.

FIG. 20 is a sectional view of the stapler cut by a face in a vertical direction along a center line of a chute.

FIG. 21 is a plane view of the cutter unit in a state of cutting a staple leg.

FIG. 22 is a sectional view taken along a line A-A of FIG. 21.

FIG. 23 is a plane view showing the cutter unit in a state of being operated to the escaping position on the rear side.

FIG. 24 is a sectional view taken along a line B-B of FIG. 23.

Further, in notations in the drawings, numeral 1 designates a stapler, numeral 3 designates a striking mechanism portion, numeral 4 designates a clincher mechanism portion, numeral 5 designates a movable clincher, numeral 10 designates a staple leg cutting mechanism (cutter unit), numeral 11 designates a fixed cutter, numeral 13 designates a movable cutter, numeral 14 designates a cutter edge, and numeral 15 designates a cutter edge.

Further, numeral 101 designates a stapler, numeral 103 designates a stapler striking mechanism portion, numeral 104 designates a clincher mechanism portion, numeral 110 designates a cutter unit, numeral 111 designates a fixed cutter member, numeral 114 designates a movable cutter, numeral 116 designates a support base, numeral 120 designates a cutting chip processing apparatus, numeral 121 designates an opening, numeral 122 designates an opening, numeral 123 designates a cutting chip containing portion, and numeral 124 designates a chute.

### BEST MODE FOR CARRYING OUT THE INVENTION

<First Exemplary Embodiment>

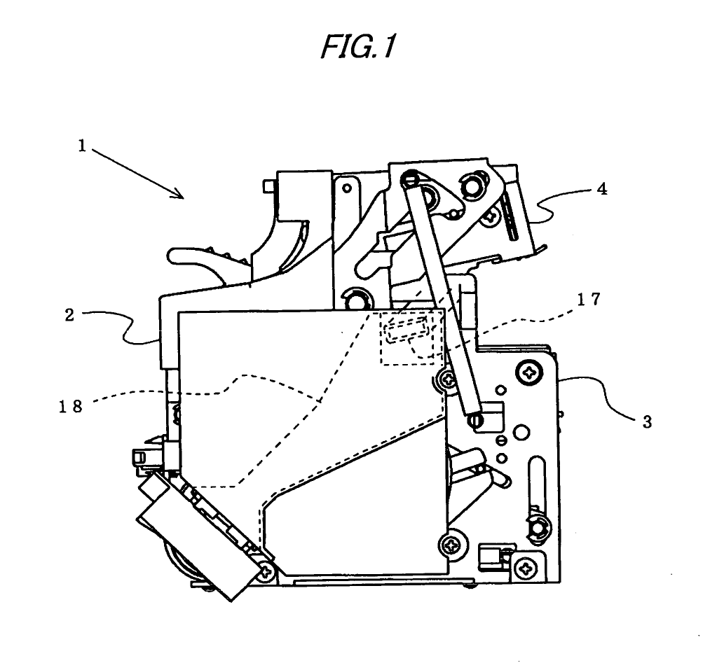

FIG. 1 is a stapler embodying a cutter unit according to a first exemplary embodiment of the invention, inside of a machine frame 2 forming an outer contour of the stapler 1 is contained with an electric motor and a drive mechanism driven to rotate by the electric motor, further, a lower portion of the machine frame 2 is formed with the striking mechanism portion 3 driven by the drive mechanism for striking out a staple formed in a C-shape to sheets to be bound. The striking mechanism portion 3 of the stapler 1 according to the embodiment is constituted to form a number of staple members in a straight shape connected with each other into the staples in the C-shape by forming means and striking out the formed staples upwardly to sheets to be bound arranged on an upper side of the striking mechanism portion 3 by strike out means. Further, an upper portion of the machine frame 2 opposed to the striking mechanism portion 3 is formed with the clincher mechanism portion 4 for folding to bend the staple leg penetrated to an upper side of the sheets to be bound along an upper face of the sheets to be bound.

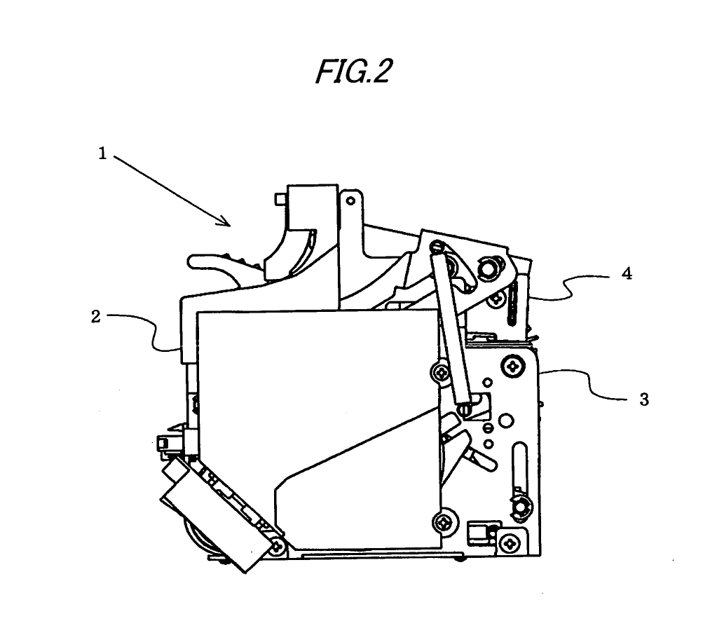

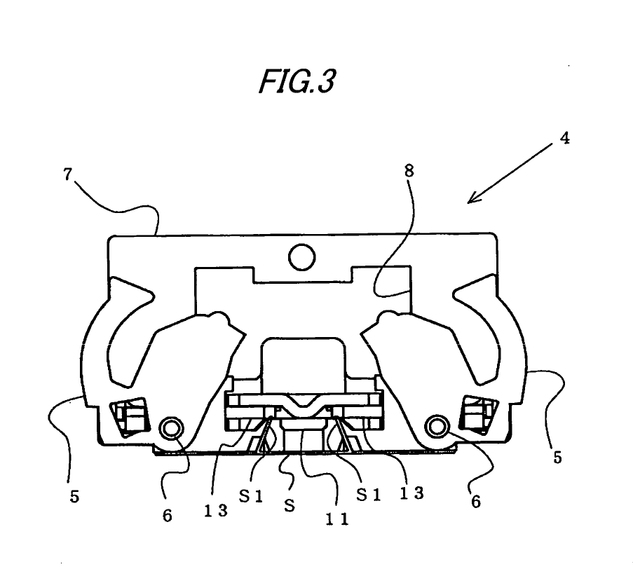

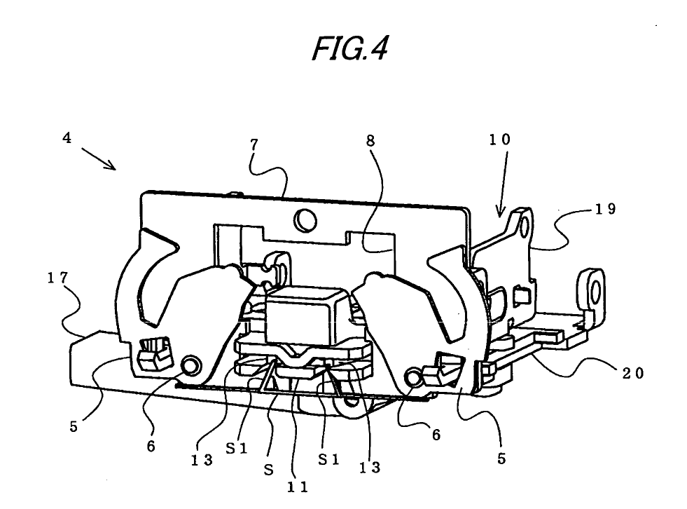

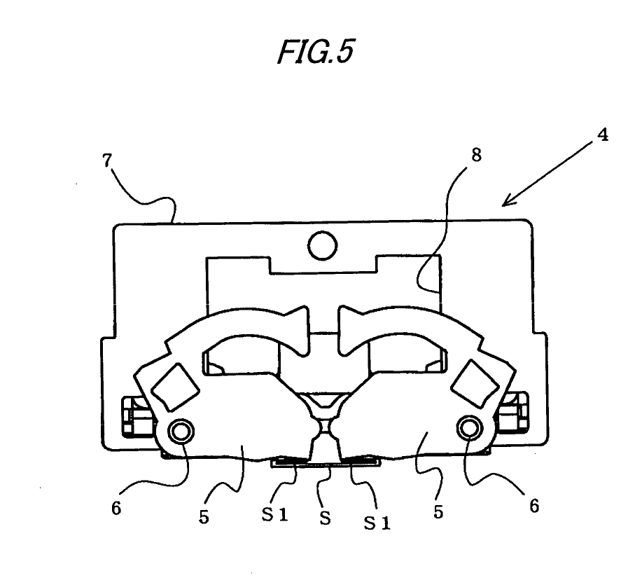

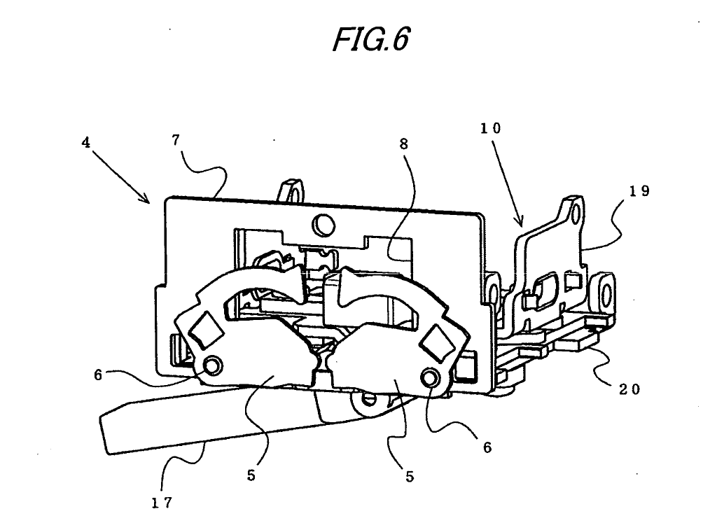

The clincher mechanism portion 4 is supported by the machine frame 2 pivotably in directions in which a front end portion thereof is proximate to and remote from the striking mechanism portion 3, and is operated to pinch the sheets to be bound between the striking mechanism portion 3 and the clincher mechanism portion 4 by operating the clincher mechanism portion 4 in the direction of the striking mechanism portion 3 as shown by FIG. 2 after the sheets to be bound are arranged between the striking mechanism portion 3 and the clincher mechanism portion 4. As shown by FIG. 3 and FIG. 4, the clincher mechanism portion 4 is provided with a pair of the movable clinchers 5 for engaging with legs of the staple projected to a side of an upper face of the sheets to be bound by penetrating the sheets to be bound and bending the staple legs along the upper face of the sheets to be bound pivotably relative to a support plate 7 respectively by pivoting shafts 6. In a state of pivoting the movable clincher 5 to a standby position as shown by FIG. 3 and FIG. 4, by striking out the staple S from the striking mechanism portion 3 to the sheets to be bound and driving to pivot the movable clincher 5 from the standby position to the operating position centering on the pivoting shafts 6 as shown by FIG. 5 and FIG. 6, the staple leg S1 penetrated through the sheets to be bound is bent along the upper face of the sheets to be bound to bind the sheets to be bound. Further, after finishing to bind the sheets to be bound, the clincher mechanism portion 4 is operated again in the direction of being remote from the striking mechanism portion 3 to be operated to an initial position shown in FIG. 1.

The staple S1 struck out from the striking mechanism portion 3 to penetrate the sheets to be bound arranged on the upper side of the striking mechanism portion 3 is engaged with the movable clincher 5 and bent along the face of the sheets to be bound, whereas a length of the staple leg S1 formed in the C-shape is a constant length, a number of sheets be bound is varied and therefore, a projected length of the staple leg S penetrated to the side of the back face of the sheets to be bound is varied in accordance with a thickness of the sheets to be bound. The clincher mechanism portion 4 is formed with the cutter unit 10 for cutting the staple leg S1 penetrated through the sheets to be bound by a pertinent length in order to form an excellent bending state by the staple S by making the projected length of the staple leg S1 penetrated through the sheets to be bound constant.

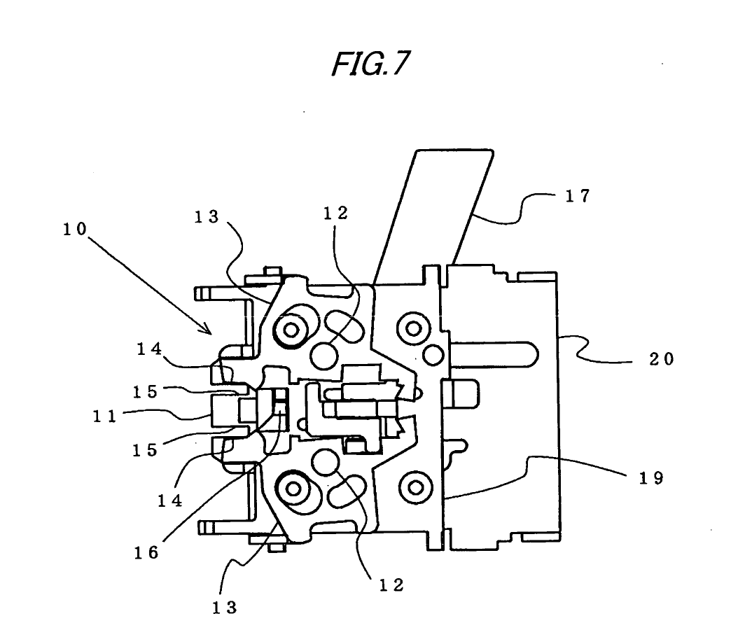

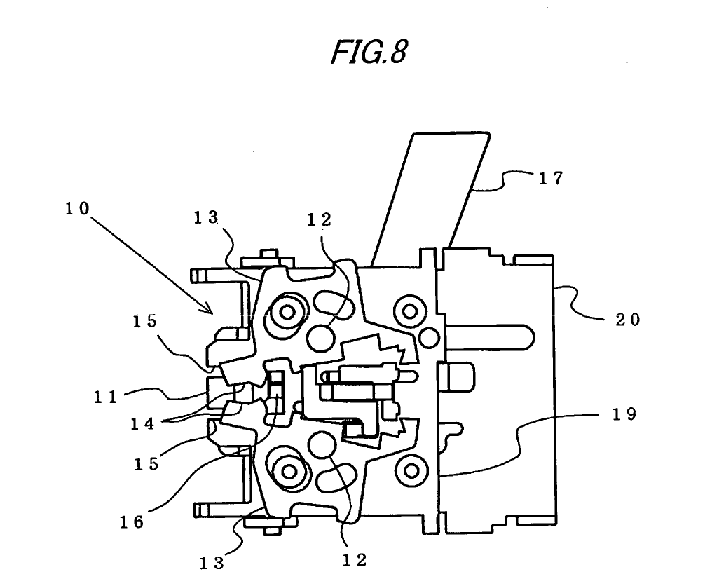

As shown by FIG. 7, the cutter unit 10 is formed by the fixed cutter 11 arranged between the pair of staple legs S1 projected to the side of the upper face of the sheets to be bound by penetrating the sheets to be bound, and a pair of the movable cutters 13 pivotably supported centering on the pivoting shafts 12 in a state of being brought into close contact with the upper face of the fixed cutter 11, with regard to the staple leg S1 arranged between the fixed cutter 11 and the movable cutter 13, as shown by FIG. 8, by pivoting the cutter edges 14 of the movable cutters 13 centering on the pivoting shafts 12 of the movable cutters 13 to operate from outer sides of the staple legs in directions of inner sides thereof, front end portions of the staple legs S1 are cut by a predetermined length between the cutting edges 15 on both sides of the fixed cutter 11 and the cutter edges 14 of the movable cutters 13. By cutting the front end portion of the staple leg S1 by operating the cutter edge 14 of the movable cutter 13 from the outer side to the inner side of the staple leg S1 in this way, a direction of a burr formed at a cut end face of the staple leg S1 is formed to direct to the inner side of the staple leg S1, that is, to a side of the sheets to be bound, and the burr is arranged in a direction of being brought into close contact with the sheets to be bound in a state of binding the sheets to be bound by the staple S.

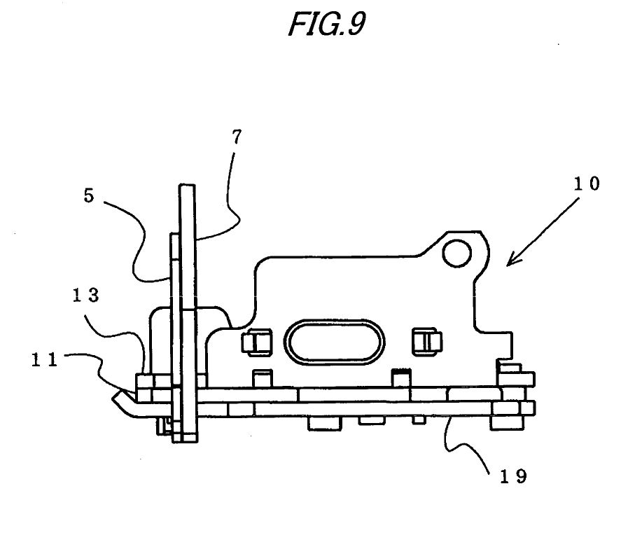

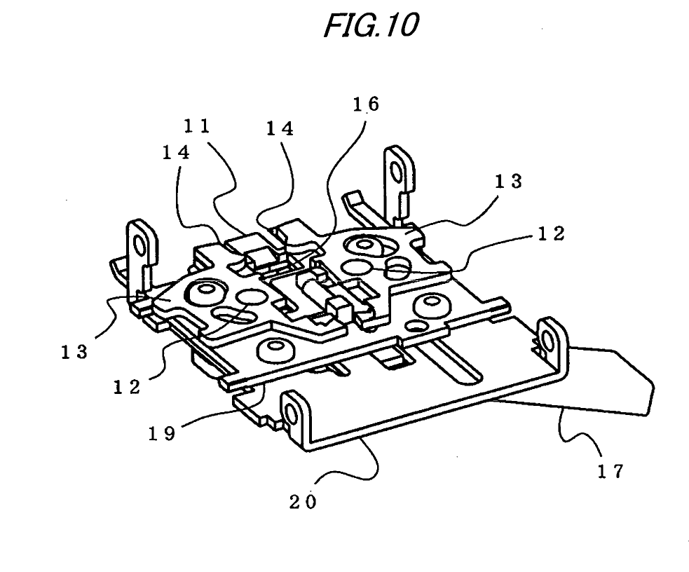

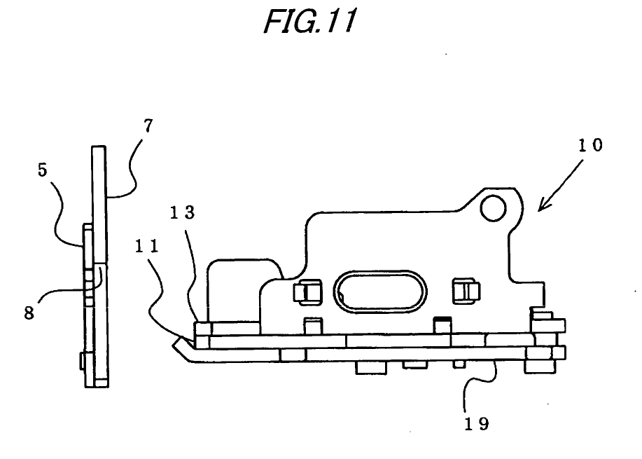

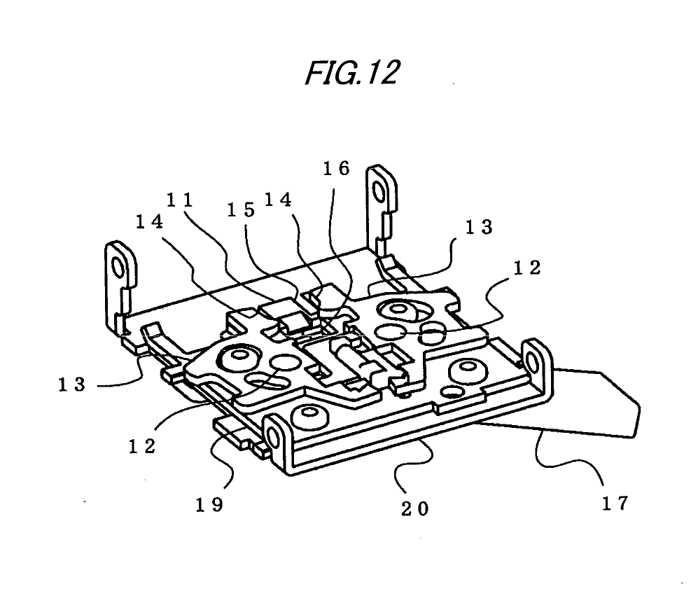

The movable clincher 5 of bending the staple leg S1 along the sheets to be bound is formed at a position opposed to a staple strike out portion for striking out the staple from the striking mechanism portion 3 of the clincher mechanism portion 4 to the sheets to be bound, further, an operation region of the movable clincher 5 opposed to the staple strike out portion of the striking mechanism portion 3 is arranged with the cutter unit 10 constituted by the fixed cutter 11 and the movable cutters 13. A slide plate 19 holding the fixed cutter 11 and the movable cutters 13 of the cutter unit 10 is slidably supported by a base 20, when the fixed cutter 11 and the movable cutters 13 of the cutter unit 10 are made to be able to advance to the staple strike out portion constituting the operation region of the movable clincher 5 from an opening portion 8 (refer to FIG. 6) formed at the support plate 7 when the movable clincher 5 is pivoted to the standby position as shown by FIG. 9 and FIG. 10. Further, in operating to pivot the movable clincher 5, as shown by FIG. 11 and FIG. 12, the cutter unit 10 is escaped from the operation region of the movable clincher, thereby, the movable clincher 5 and the cutter unit 10 are prevented from being interfered with each other.

When the movable clincher 5 is pivoted to the standby position as shown by FIG. 3 and FIG. 4, as shown by FIG. 9 and FIG. 10, the respective cutter edges 14, 15 of the fixed cutter 11 and the movable cutter 13 of the cutter unit penetrate the opening portion 8 formed at the support plate 7 to be projected to a front side, advanced to between the pair of movable clinchers 5 pivoted to the standby positions to be arranged to be opposed to the staple strike out portion, the front end portion of the staple leg S1 struck out from the staple strike out portion of the striking mechanism portion 3 and penetrated through the sheets to be bound is cut by the cutter unit 10, as shown by FIG. 11 and FIG. 12, the cutter unit 10 is operated to escape from between the movable clinchers 5, the movable clincher 5 is operated to pivot to fold the staple leg S1 cut to the predetermined length along the back face of the sheets to be bound to be operated to bind the sheets to be bound.

Further, in order to prevent the cutting chip cut by the cutter unit 10 from advancing to the drive mechanism or the like or a clearance of a part of the stapler to bring about the operational hazard or the like in the drive mechanism or the like, the cutting chip cut by the fixed cutter 11 and the movable cutter 13 of the cutter unit 10 is made to be dropped onto a chute 17 formed on a side of a lower face of the cutter unit 10 by way of an opening 16 formed on a rear side of the cutter edge 15 of the fixed cutter 11 and is guided into a chip case 18 formed at a side face of the machine frame 2 by the chute 17 to be stored into the chip case 18.

The operational state of the embodiment will be explained as follows. In an initial state, as shown by FIG. 1, the clincher mechanism portion 4 is arranged in a state of being operated upward relative to the striking mechanism portion 3, and a gap is formed between the upper face of the striking mechanism portion 3 and the lower face of the clincher mechanism portion 4 to be able to insert the sheets to be bound. Further, as shown by FIG. 4, the movable clincher 5 of the clincher mechanism portion 4 is operated to be pivoted to the standby position and the cutter unit 10 is operated to the escaping position shown in FIG. 11 and FIG. 12.

When the sheets to be bound are arranged between the striking mechanism portion 3 and the clincher mechanism portion 4, as shown by FIG. 2, the clincher mechanism portion 4 is operated in the direction of the striking mechanism portion 3 and the sheets to be bound are pinched between the clincher mechanism portion 4 and the striking mechanism portion 3. In synchronism therewith, the cutter unit 10 is slided to move to the front side and the cutter edges 14, 15 of the fixed cutter 11 and the movable cutter 13 are arranged at positions opposed to the stable strike out portion of the striking mechanism portion 3 as shown by FIG. 8 and FIG. 9. Thereafter, the staple formed into the C-shape by the staple strike out mechanism of the striking mechanism portion 3 is struck to the sheets to be bound pinched between the striking mechanism portion 3 and the clincher mechanism portion 4, and the pair of staple legs S1 are penetrated through the sheets to be bound and arranged on both sides of the fixed cutter 11 arranged on the side of the upper face of the sheets to be bound.

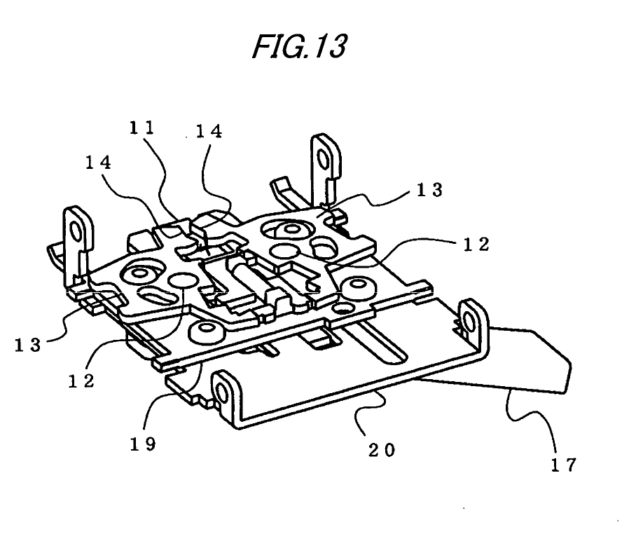

At a time of finishing to strike the staple S by the striking mechanism portion 3, as shown by FIG. 8 and FIG. 13, the pair of movable cutters 13 of the cutter unit 10 are operated to pivot centering on the pivoting shafts 12, thereby, the front end portions of the staple legs S1 are cut by the cutter edges 14 of the movable cutters 13 and the cutter edges 15 of the fixed cutter 11. The fixed cutter 11 and the movable cutter 13 of the cutter unit 10 are arranged at constant positions from the upper face of the sheets to be bound and therefore, the length of the staple leg after cutting the front end by the fixed cutter 11 and the movable cutter 13 always becomes the constant length. Further, at this occasion, an inner side face on a base side of the staple leg is supported by the cutter edge 15 of the fixed cutter 11, a portion of a front end side of the staple leg is moved from the outer side to the inner side by the cutter edge 14 of the movable cutter 13 and therefore, the burr formed at the cutting face of the staple leg is formed to direct to the inner side of the staple leg S1, that is, the side of the sheets to be bound.

After finishing to cut the front end portion of the staple leg S1 by the cutter unit 10, as shown by FIG. 11 and FIG. 12, the cutter unit 10 is operated to escape from the position opposed to the staple strike out portion, that is, the operation region of the movable clincher 5, thereby, the movable clincher 5 is made to be able to be pivoted, as shown by FIG. 5 and FIG. 6, the pivoting clincher 5 is operated to pivot centering on the pivoting shaft 6 and the staple leg cut by the predetermined length is bent along the upper face of the sheets to bound to thereby finish the series of staple binding operation.

Further, when the cutter unit 10 is arranged at the standby position shown in FIG. 11 and FIG. 12, the cutting chip of the staple leg cut by the movable cutter 13 is dropped onto the chute 17 formed on the side of the lower face of the cutter unit 10 by way of the opening 16 formed on the rear side of the fixed cutter and the cutting chip guided by the chute 17 is guided and stored into the chip case 18 formed at the side face of the machine frame 2.

As described above, the front end of the staple leg S1 is cut such that the length of the staple leg S1 after being cut by the cutter unit 10 becomes always the constant length and therefore, even when thin sheets to be bound are bound, the front end of the staple leg S1 is not re-penetrated through the sheets to be bound again to be projected to the side of the surface and stable binding condition can be maintained. Further, the burr formed by the cutting face of the staple leg S1 is formed to direct to the inner side of the stale leg S1, that is, to the side of the face of the sheets to be bound and therefore, in the staple binding state, the sheets are bound in a state in which the burr at the front end face of the staple leg S1 is brought into close contact with the side of the rear face of the sheets to be bound, even when the hand is brought into contact with the staple leg S1 after binding the sheets by the staple, the hand is not brought contact with the burr and there is not a concern of being injured by the burr produced by cutting the staple leg S1.

Further, the cutter unit 10 is arranged to be able to slide to move between the position opposed to the staple strike out portion constituting the operation region to pivot the movable clincher 5 and the position of escaping from the operation region to pivot the movable clincher 5, the cutter unit 10 is made to advance to between the movable clinchers 5 pivoted to the escaping positions, after cutting the staple leg, the cutter unit 10 is escaped from between the movable clinchers 5, the cut staple leg is bent by the movable clincher 5 and therefore, the length of the portion of the movable clincher 5 engaged with the staple leg S1 can be formed to be large and the stable binding shape can be formed by engaging the movable clincher with the front end portion of the staple leg S1.

<Second exemplary embodiment>

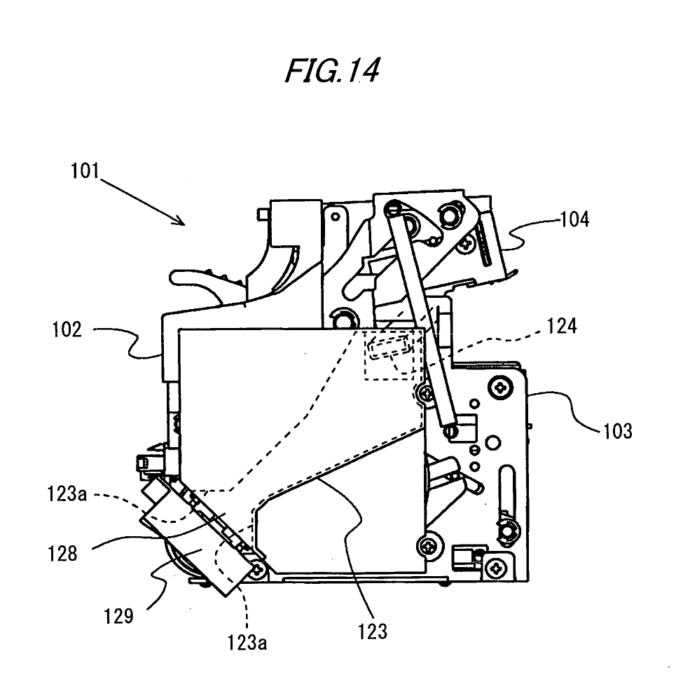

FIG. 14 is a side view showing the stapler 101 embodying a staple leg cutting chip processing apparatus according to a second exemplary embodiment of the invention. Inside of a machine frame 102 forming an outer contour of the stapler 101 is contained with an electric motor and a drive mechanism driven to rotate by the electric motor, further, a lower portion of the machine frame 102 is formed with the striking mechanism portion 103 driven by the drive mechanism for striking out a staple formed in a C-shape to sheets to be bound. The striking mechanism portion 103 of the stapler 101 according to the embodiment is constituted to supply a number of staple members in a straight shape connected to each other successively to a staple strike out portion of the striking mechanism 103, form the staple member supplied to the staple strike out portion into the staple in the C-shape by forming means and strike out the formed staple upwardly from a lower face side to an upper face side of the sheets to be bound arranged on an upper side of the striking mechanism portion 103 by strike out means formed at the staple strike out portion. Further, an upper portion of the machine frame 102 opposed to the striking mechanism portion 103 is formed with the clincher mechanism portion 104 for folding to bend a staple leg penetrated to a side of an upper face of the sheets to be bound along an upper face of the sheets to be bound.

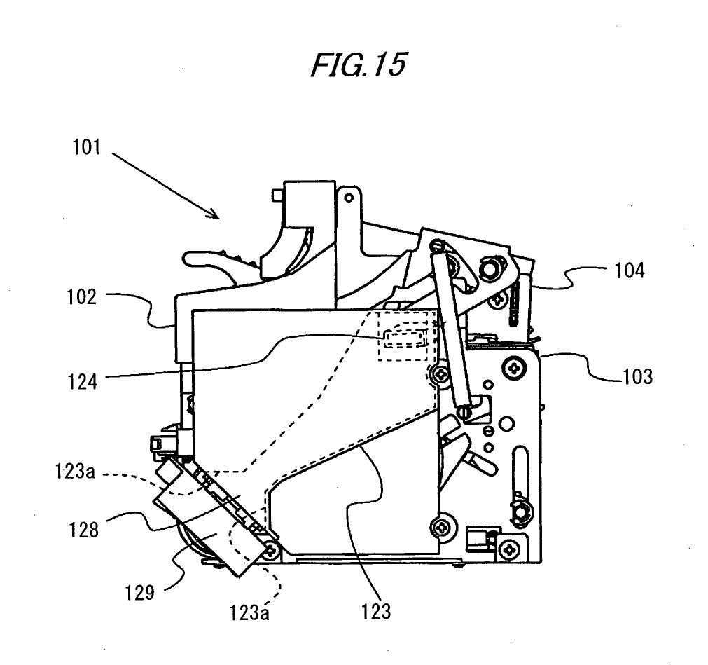

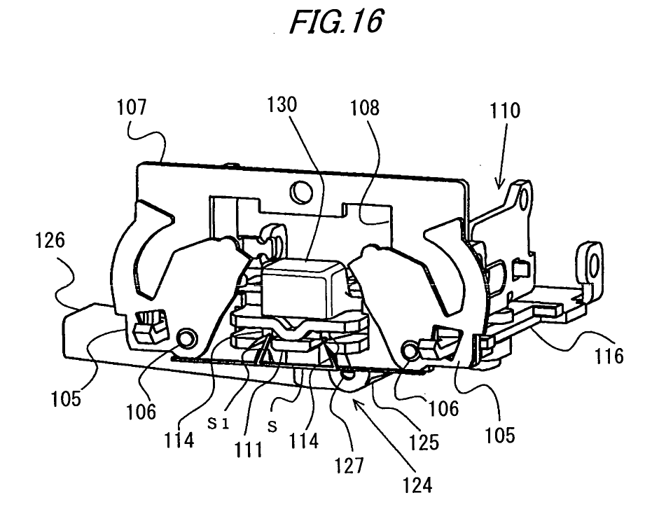

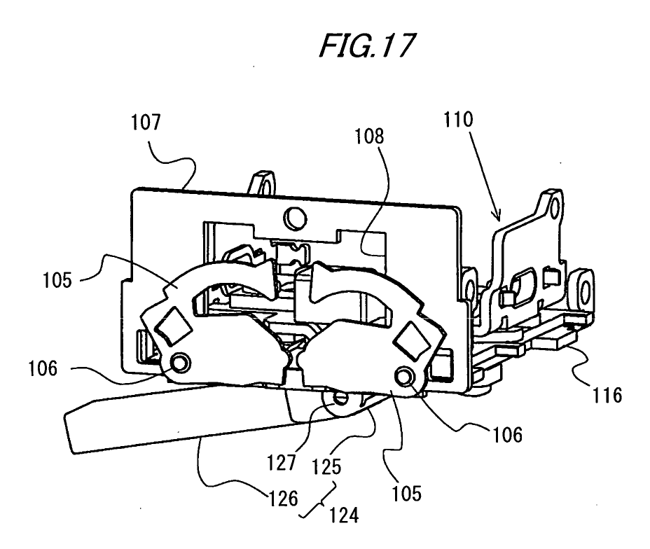

The clincher mechanism portion 104 is pivotably supported by the machine frame 102, after arranging the sheets to be bound between the striking mechanism portion 103 and the clincher mechanism portion 104, as shown by FIG. 15, the clincher mechanism portion 104 is operated to pivot in a direction of the striking mechanism portion 103 to be operated to pinch the sheets to be bound between the striking mechanism portion 103 and the clincher mechanism portion 104. At the clincher mechanism portion 104, as shown by FIG. 16, a pair of movable clinchers 105 engaged with legs of the staple S penetrating through the sheets to be bound and projected to the side of the upper face of the sheets to be bound for bending the staple legs S1 along the upper face of the sheets to be bound are provided respectively pivotably by pivoting shafts 106 relative to a support plate 107. By operating to pivot the movable clincher 105 from a standby position shown in FIG. 16 to an operating position shown in FIG. 17 centering on the pivoting shaft 106, the staple leg S1 penetrated through the sheets to be bound and projected to the side of the upper face is bent along the upper face of the sheets to be bound.

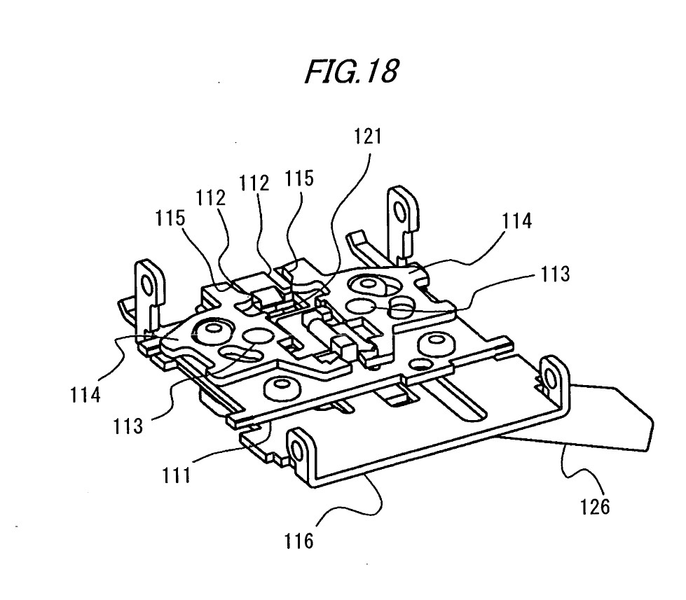

Further, the clincher mechanism portion 104 is formed with the cutter unit 110 for cutting a front end portion of the staple leg S1 such that a length of a portion projected from the sheets to be bound of the staple leg S1 penetrated through the sheets to be bound is made to be a constant length. As shown by FIG. 18, the cutter unit 110 is constituted by the fixed cutter member 111 in a plate-like shape a front end portion of which is formed with a cutter edge 112 arranged between the pair of staple legs S1 penetrated through the sheets to be bound and projected to the side of the upper face of the sheets to be bound, and a pair of the movable cutters 114 pivotably supported centering on pivoting shafts 113 in a state of being brought into close contact with an upper face of the fixed cutter member 111 in the plate-like shape, front ends of the pair of respective movable cutters 114 are formed with cutter edges 115 opposed to the cutter edges 112 of the fixed cutter member 111, with regard to the staple leg S1 arranged between the respective cutter edges 112, 115, by pivoting the movable cutter 114 centering on the pivoting shafts 113 such that the cutter edge 115 of the movable cutter 114 is operated to direct from an outer side to an inner side direction of the staple leg S1, a front end portion of the staple leg S1 is cut by a predetermined length between the cutter edge 115 of the movable cutter 114 and the cutter edge 112 of the fixed cutter member 111.

The fixed cutter member 111 in the plate-like shape forming the cutter unit 110 is slidably supported by an upper face of the support base 116 formed on a rear side of the support plate 107 supporting the movable clincher 105 and the cutter unit 110 is made to be able to slide to move such that portions of the cutter edges 112, 115 can advance from the striking mechanism portion 103 to a position in correspondence with a staple strike out position for striking out the staple and escape from the position to a rear side. As shown by FIG. 16 and FIG. 18, when the movable clincher 105 is pivoted to the standby position, the cutter unit 110 is moved to the front side, the cutter edges 112, 115 of the fixed cutter member 111 and the movable cutter 114 are arranged to advance from an opening portion 108 formed at the support plate 107 to a staple strike out portion constituting an operation region to pivot the movable clincher 105, and the front end portion of the staple leg S1 struck out from the striking mechanism portion 103 and penetrated through the sheets to be bound is cut by rotating the movable cutter. Further, after cutting the staple leg S1, the cutter unit 110 is moved to slide to the rear side to escape from the operation region of the movable clincher 105, thereby, staple binding is carried out by bending the staple leg S1 cut by the cutter unit 110 along the rear face of the sheets to be bound without interfering the movable clincher 105 with the cutter unit 110.

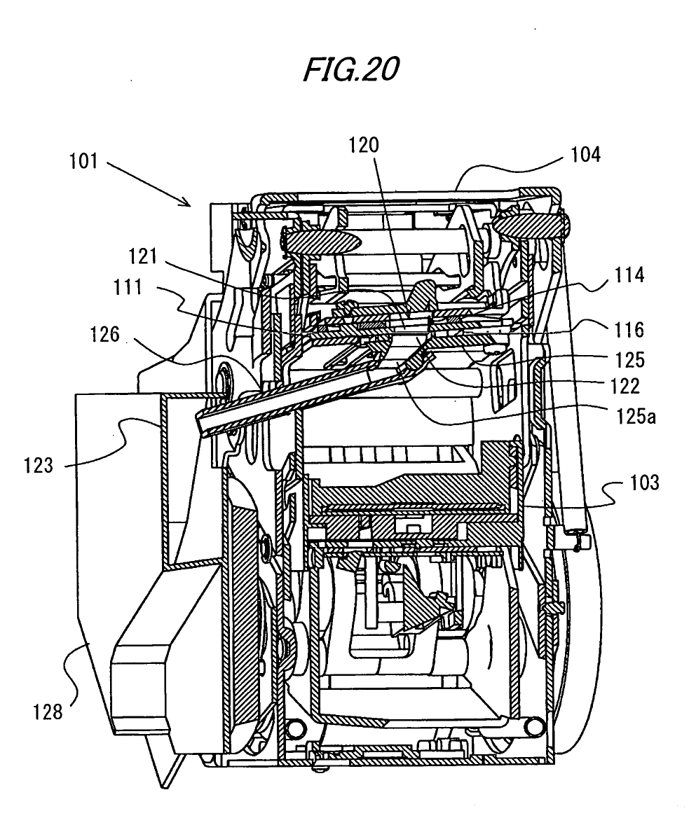

The stapler 1 is formed with a cutting chip processing apparatus 120 for preventing a cutting chip of the staple leg S1 produced when the staple leg S1 is cut by the cutter unit 110 from scattering into the stapler 101. As shown by FIG. 20, the cutting chip processing apparatus 120 is constituted by the opening 121 formed at the fixed cutter member 111 in the plate-like shape formed with the cutter edge 112 at the front end portion to penetrate from an upper face side to a lower face side of the fixed cutter member 111, the opening 122 formed at the support base 116 for slidably supporting the fixed cutter member 111 to penetrate from an upper face side to a lower face side of the support base 116, the cutting chip containing portion 123 formed at the side face of the machine frame 102, and the chute 124 one end side (first end portion) of which is arranged on the lower face side of the support base 116 to be continuous to the opening 122 formed at the support base 116 and other end side (second end portion) is arranged at inside of the cutting chip containing portion 123.

The opening 121 formed at the fixed cutter member 111 and the opening 122 formed at the support base 116 are respectively formed at positions at which the two openings 121, 122 are matched when the cutter unit 110 is made to slide to move to the rear position, when the cutter unit 110 is arranged to the position, the cutting chip cut by the cutter unit 110 is dropped to discharge to a lower face side of the support base 116 by way of the two openings 121, 122, and discharged to the cutting chip containing portion 123 by way of the chute 124 arranged continuously to the lower face side of the opening 122 of the support base 116. When the cutter unit 110 is made to slide to move to a staple strike out position on a front side for cutting the staple leg, the two openings 121, 122 are arranged at positions shifted from each other, and the cutting chip is contained at inside of the opening 121 formed at the upper face of the fixed cutter member 111 or the fixed cutter member 111.

The chute 124 arranged on the lower face of the support base 116 is constituted by a first chute 125 mounted to the back face of the support base 116 to cover a lower face side of the opening 122 formed at the support base 116, and a second chute 126 one end side of which is pivotably supported by a portion of a discharge port 125a of the first chute 125 and other end side of which is arranged at inside of the cutting chip containing portion 123 formed at the side face of the machine frame 102 of the stapler 101, and the cutting chip is discharged into the cutting chip containing portion 123 by making an inclination angle of the second chute 126 large by pivoting a side of a pivotably supporting portion 127 of the second chute 126 in an upper direction by operating the clincher mechanism portion 104 in a direction of being separated from the striking mechanism portion 103.

A lower portion of the cutting chip containing portion 123 is formed with an opening 128 inclined by an angle of substantially 45 degrees for discharging the cutting chip stored at inside of the cutting chip containing portion 123 from inside of the cutting chip containing portion 123, and the opening 128 is mounted with a lid member 129 for closing the opening 128 at normal times. An inner wall face 123a continuous to the opening 128 of the cutting chip containing portion 123 is formed by a vertical or horizontal wall face to be able to prevent that when the cutting chip at inside of the cutting chip containing portion 123 is discharged, the cutting chip stays at the inner wall face of the cutting chip containing portion 123 or an edge portion of the opening 128, the cutting chip is pinched between the lid member 129 and the edge of the opening, the lid member 129 is not completely closed and the cutting chip runs out therefrom.

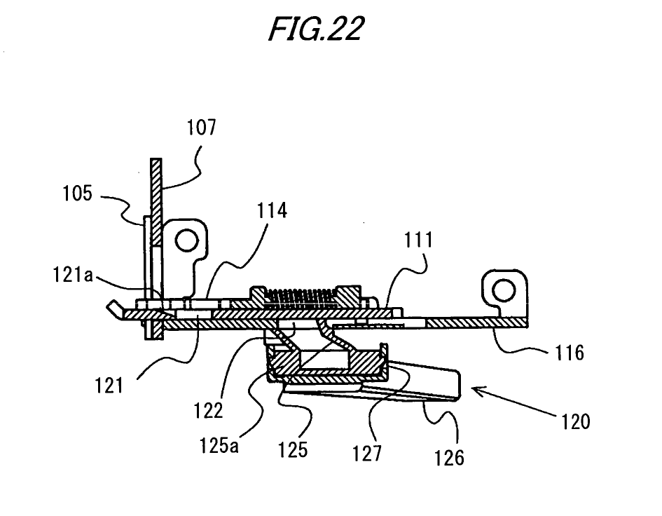

Further, as shown by FIG. 16, a cover 130 is mounted to cover the respective cutter edges 112, 115 of the fixed cutter member 111 and the movable cutter 114 and an upper portion of the opening 121 formed at the fixed cutter member 111, the cutting chip cut by the fixed cutter member 111 and the movable cutter 114 is prevented from being scattered to a surrounding and even when the stapler 101 is arranged in a vertical direction to close a lower end portion of the sheet arranged in the vertical direction, the cutting chip is guided to the opening 121 formed at the fixed cutter member 111 by the cover 130. Further, as shown by FIG. 22, an inclined face 121a is formed at an edge on a front side proximate to the cutter edge 112 of the opening 121 formed at the fixed cutter member 121, and by the inclined face 121a, the cutting chip cut by the cutter edges 112, 115 of the fixed cutter member 111 and the movable cutter 114 is guided into the opening 121 and is guided to the chute 124 by way of the opening 122 formed at the support base 116.

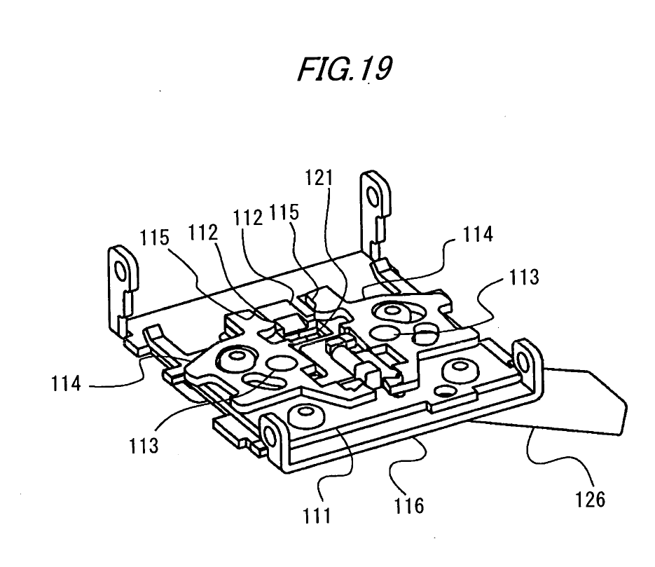

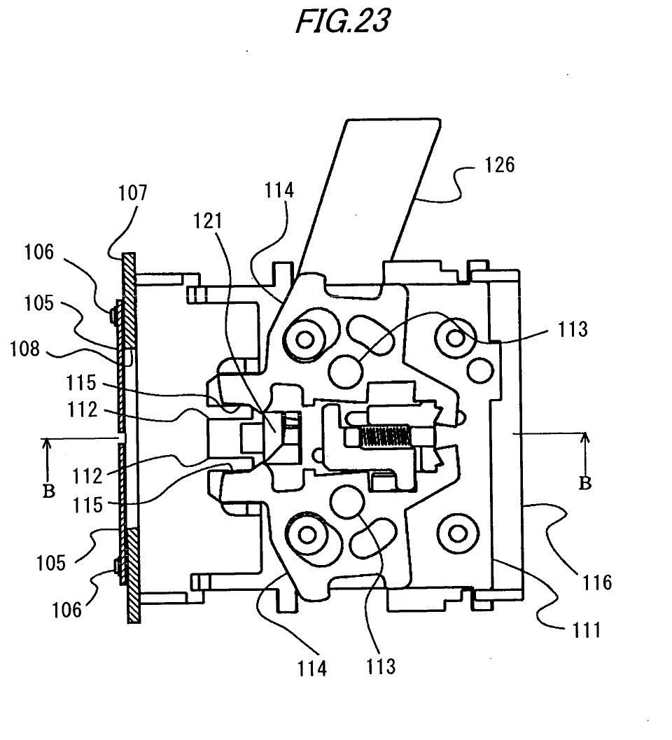

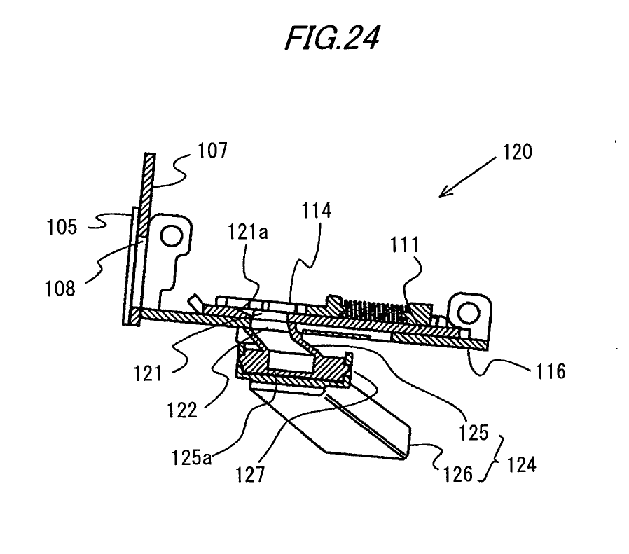

An explanation will be given of operation of the cutting chip processing apparatus 120 of the staple leg according to the second exemplary embodiment as follows. In an initial state, as shown by FIG. 14, the clincher mechanism portion 104 is arranged in a state of being operated to an upper side relative to the striking mechanism portion 103, and a gap is formed between the upper face of the striking mechanism portion 103 and the lower face of the clincher mechanism portion 104 to be able to insert the sheets to be bound. Further, as shown by FIG. 16, the movable clincher 105 of the clincher mechanism portion 104 is operated to pivot to the standby position, and as shown by FIG. 19, FIG. 23 and FIG. 24, the cutter unit 110 is operated to slide to the escaping position on the rear side in a state of opening the cutter edge 115 formed at the front end of the movable cutter 114.

When the sheets to be bound are arranged between the striking mechanism portion 103 and the clincher mechanism portion 104, as shown by FIG. 15, the clincher mechanism portion 104 is operated in the direction of the striking mechanism portion 103 to pinch the sheets to be bound between the clincher mechanism portion 104 and the striking mechanism portion 103. In synchronism therewith, as shown by FIG. 18, the cutter unit 110 is made to slide to move to the front side, and the respective cutter edges 112, 115 of the fixed cutter member 111 and the movable cutter 114 are arranged at positions opposed to the staple strike out portion of the striking mechanism portion 103. At the time, the cutter edge 115 of the movable cutter 114 stays to be opened, thereafter, the staple S formed in the C-shape by the striking mechanism portion 103 is struck to the sheets to be bound pinched between the striking mechanism portion 103 and the clincher mechanism portion 104, the pair of staple legs S1 are penetrated through the sheets to be bound and arranged on both sides of the cutter edges 112 formed at the front end portion of the fixed cutter member 111 arranged on the upper face side of the sheets to be bound.

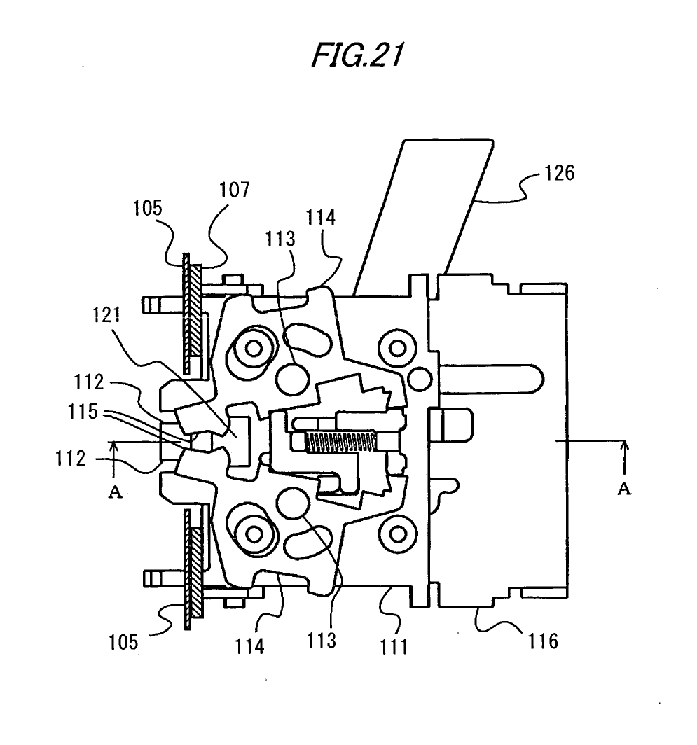

At a time of finishing to strike the staple S by the striking mechanism portion 103, as shown by FIG. 21, the pair of movable cutters 114 of the cutter unit 110 are operated to pivot centering on the pivoting shafts 113, thereby, the cutter edges 115 formed at front ends of the pair of movable cutters 114 are operated in directions of being proximate to each other, and front end portions of the staple legs S1 are cut by the cutter edges 115 of the movable cutters 114 and the cutter edges 112 of the fixed cutter member 111. In a state in which the cutter edges 112, 115 of the cutter unit 110 advance to the staple strike out portion as described above, as shown by FIG. 22, the opening 121 formed at the fixed cutter member 111 and the opening 122 formed at the support base 116 are arranged at positions shifted from each other and therefore, the cutting chip is guided by the inclined face 121a or the like formed at the front edge of the opening 121 of the fixed cutter member 111 and is guided to inside of the opening 121 formed at the fixed cutter member 111.

After finishing to cut the front end portion of the staple leg by the cutter unit 110, the cutter unit 110 is operated to escape to the rear side from the position opposed to the staple strike out portion, that is, the operation region of the movable clincher 105 as shown by FIG. 19 and FIG. 23, thereby, the movable clincher 105 is made to be able to be pivoted, as shown by FIG. 17, the pivoting clincher 105 is operated to pivot centering on the pivoting shaft 106, the staple leg cut to the predetermined length is bent along the upper face of the sheets to be bound to thereby finish the series of staple binding operation. The movable cutters 114 are operated to pivot centering on the pivoting shafts 113 in directions in which the cutter edges 115 formed at the front ends are separated from each other after operating the cutter unit 110 to the escaping position on the rear side shown in FIG. 19 and FIG. 23.

When the cutter unit 110 is operated to slide to the escaping position on the rear side, as shown by FIG. 24, there is brought about a state in which the opening 121 formed at the fixed cutter member 111 and the opening 122 formed at the support base 116 coincide with each other, the cutting chip guided into the opening 121 of the fixed cutter member 111 is dropped onto the second chute 126 by way of the opening 122 of the support base 116 and by way of the first chute 125 mounted to the lower face side of the support base 116. In synchronism with operating the cutter unit 110 to the standby position on the rear side, the clincher mechanism portion 104 which has clinched the staple leg S1 is operated to pivot to the upper side to be separated from the striking mechanism portion 103. By pivoting the clincher mechanism portion 104, the pivotable supporting portion 127 of the second chute 126 is moved to the upper side to pivot to increase the inclination angle of the second chute 126 and the cutting chip dropped to the second chute 126 is discharged to inside of the cutting chip containing portion 123.

As described above, the cutting chip cut by the fixed cutter member 111 and the movable cutter 114 of the cutter unit 110 is dropped onto the chute 124 formed on the lower face side of the support base 116 by way of the opening 121 formed on the rear side of the cutter edge 112 of the fixed cutter member 111 and the opening 122 formed at the support base 116 slidably supporting the cutter unit 110, the cutting chip is guided into the cutting chip containing portion 123 formed at the side face of the machine frame 102 by the chute 124 to be stored into the chip containing portion 123 and therefore, it can be prevented that the cutting chip of the staple leg cut by the cutter unit 110 advances to the drive mechanism and the clearance of the operating part of the stapler 101 to bring about the operational hazard of the drive mechanism or the like.

### INDUSTRIAL APPLICABILITY

The stapler of the invention is provided with the cutter unit comprising the fixed cutter arranged between the staple legs and the pair of movable cutters formed with the cutter edges operated from the outer side to the inner side of the staple legs relative to the fixed cutter, the cutter unit is arranged slidably between the position advanced into the operation region of the movable clincher opposed to the staple strike out portion of the striking mechanism and the position escaped from the operation region of the movable clincher and therefore, the stable clinch shape can be provided by the movable clincher, further, there is not a concern of being injured by the burr formed at the front face of the staple leg.

Further, the stapler of the invention is constituted such that the cutter unit for cutting the staple leg is arranged slidably between the staple strike out position and the escaping position on the rear side of the position, after arranging the cutter unit at the staple strike out position to cut the staple leg, the cutter unit is moved to the escaping position on the rear side and at the position, the cutting chip is discharged to the rear face side of the cutter unit, the cutting chip is guided to the chip containing portion by the chute and therefore, the stapler can be installed in directions capable of binding the sheets to be bound arranged in either of the horizontal direction or the vertical direction, and the cutting chip of the staple leg can firmly be guided to the chip containing portion.

1. A stapler comprising:
a striking mechanism portion;
a movable clincher for folding to bend staple legs penetrated through a bundle of sheets to be bound of a staple struck out from the striking mechanism portion along a back face of the bundle of sheets to be bound by being pivoted from a standby position to an operating position; and
a cutter unit,
wherein the cutter unit comprises a fixed cutter and a movable cutter,
the cutter unit is arranged slidably between a position advanced into an operation region of the movable clincher opposed to a staple strike out portion of the striking mechanism and a position escaped from the operation region of the movable clincher,
when the movable clincher is pivoted to the standby position, the cutter unit advances to the operation region of the movable clincher to cut the staple leg penetrated through the sheet to be bound, and
after escaping the cutter unit from the operation region of the movable clincher, the movable clincher is pivoted to the operating position to bend the staple leg cut by a predetermined length along the sheet to be bound.

2. The stapler according to claim 1, when the cutter unit advances to the operation region of the movable clincher, the fixed cutter is positioned between the staple legs penetrated through the sheet to be bound and the movable cutter is operated from an outer side to an inner side of the staple legs relative to the fixed cutter to cut the staple legs.

3. The stapler according to claim 1, further comprising:
an opening formed at the cutter unit; and
a chute arranged on a side of a lower side of the cutter unit,
wherein a cutting chip of the staple legs is discharged to a side of a lower face of the cutter unit by way of the opening at a position at which the cutter unit is escaped from the operation region of the movable clincher and is guided into a chip containing portion by way of the chute.

4. The stapler according to claim 3, wherein the chute comprises:
a first end portion arranged on the side of the lower face of the cutter unit and comprising a pivotably supporting portion for pivotably supporting the chute; and
a second end portion arranged in the chip containing portion,
wherein the pivotably supporting portion is moved to an upper side such that an inclination angle of the chute is increased by operating to pivot the clincher.
